(19) United States
(12) Patent Application Publication
(10) Pub. No.: US 2004/0184728 A1
(43) Pub. Date: Sep. 23, 2004

(54) Optical fiber system

(76) Inventors: Cheng-Hsi Miao, San Jose, CA (US); Ying-Moh Liu, Saratoga, CA (US)

Correspondence Address: Billy Lau, 486 Vista Del Norte, Walnut, CA, 91789-1605, US

(21) Appl. No.: 10/392,208

(22) Filed: Mar. 18, 2003

(51) Int. Cl. G02B 6/32

(52) U.S. Cl. 385/33; 385/93

(57) ABSTRACT

The present invention relates to optical fiber system that employs an improved optical fiber collimator. The improved optical fiber collimator includes a housing, optical fiber, and a lens system of one or more lenses. The improved optical fiber does not require the fiber ferrule employed in a conventional optical fiber collimator design.

### FIELD OF THE INVENTION

This invention generally relates to optical fiber technology. Particularly, this invention relates to an optical fiber system that employs improved optical fiber collimators.

### BACKGROUND OF THE INVENTION

Optical fiber technology is widely applied in the field of communication, including telecommunication, data communication, cable television, and fiber-to-home applications. Other representative applications of optical fiber technology include illumination and imaging. One of the key components in optical fiber technology is the optical fiber collimator. In many applications, the optical fiber collimator optically couples an optical fiber to an optical component. Representative optical components that couple through optical fiber collimators to optical fibers include optical attenuator, optical switches, photodetector, light sources, acousto optic devices, and electro optic devices. One skilled in the art understands that the optical fiber collimator has other applications. Optical fiber systems, in particular, optical fiber communication systems, employ a large quantity of optical fiber collimators. Most of the optical fibers employed in an optical fiber system are terminated with optical fiber collimators.

There are numerous prior art optical fiber collimator designs. Until recently, the most important design goal for passive optical components employed in an optical fiber communication system was optimal optical transmission performance. The laser signal sources employed in the optical fiber communication system were expensive compared to the passive components employed in the system. These passive components included optical fiber collimators. By optimizing the transmission performance of passive optical components in an optical communication system, the lowest power and therefore the least expensive laser signal source could be employed in the system. FIGS. 1 through 5 illustrate a selection of representative prior art optical fiber collimator designs. Many of these prior art designs are optimized for optical transmission performance.

FIG. 1 shows a prior art optical fiber collimator design. Referring to FIG. 1, optical fiber 107 attaches to fiber ferrule 1. Fiber ferrule 1 provides support for optical fiber 107. In the fabrication process of this optical fiber collimator, optical fiber 107 is inserted into fiber ferrule 1 and secured to fiber ferrule 1 with an adhesive. Then the end of optical fiber 107 and the end of fiber ferrule 1 are polished to form optical fiber termination 108. To reduce reflection and to improve optical transmission performance, the surface of optical fiber termination 108 is polished so that it is at an angle to the surface that is perpendicular to the axis of the fiber ferrule, which is essentially the same as the optical axis of optical fiber 107 at optical fiber termination 108. Collimating lens 109 is placed at a distance from fiber termination 108. Similar to the surface at optical fiber termination 108, the surface of collimating lens 109 that is facing optical fiber termination 108 is polished so that it is at an angle to the surface that is perpendicular to the optical axis of collimating lens 109. This angle is introduced to the collimating lens design to reduce reflection and to match the corresponding angle of optical fiber 107 at optical fiber termination 108. During the alignment phase in the fabrication process, the optical axis of optical fiber 107 at optical fiber termination 108 and the optical axis of collimating lens 109 are aligned. Then the relative distance between optical fiber termination 108 and collimating lens 109 is adjusted, and collimating lens 109 is rotated about its optical axis for optimal optical transmission performance. Typically, fiber ferrule 1 and collimating lens 109 are attached to a base plate through support structures in this design after the alignment phase is completed. Other parameters that may be adjusted during the alignment phase include the relative offset and the angle between the optical axes. The design shown in FIG. 1 allows for the adjustment of many parameters during alignment to achieve optimal optical transmission performance. Nevertheless, the alignment process in the fabrication of this design is labor intensive and costly because many parameters in this design require adjustment.

FIG. 2 shows another prior art optical fiber collimator design. It is an improvement to the one shown in FIG. 1. Referring to FIG. 2, housing 101 is introduced in this design as a support member for fiber ferrule 1 and collimating lens 109. Optical fiber 107 attaches to fiber ferrule 1. Fiber ferrule 1 and collimating lens 109 attach to housing 101. Housing 101 limits the adjustments that can be made during the alignment of this design to the relative distance and the angular orientation between optical fiber termination 108 and collimating lens 109. The labor cost for aligning this design is thus reduced compared to the design depicted in FIG. 1.

The prior art design shown in FIG. 3 is a variation of the prior art design shown in FIG. 1. Referring to FIG. 3, optical fiber 107 attaches to fiber ferrule 1. Fiber ferrule 1 attaches to collimating lens 109 with a transparent adhesive 2. The alignment labor cost for this design is expected to be approximately the same as that of FIG. 1.

FIG. 4 shows another prior art design. It is a variation of the design shown in FIG. 2. Compared to the design shown in FIG. 2, the design shown in FIG. 4 has an additional second housing 4. Referring to FIG. 4, optical fiber 107 attaches to fiber ferrule 1 and collimating lens 109 attaches to second housing 4. Fiber ferrule 1 and second housing 4 attaches to first housing 3. The addition of second housing 4 allows for the adjustment of the relative offset between the optical axes of optical fiber 107 at optical fiber termination 108 and collimating lens 109 during the alignment process in the fabrication of this design to achieve the desirable optical transmission performance.

FIG. 5 shows yet another prior art design. There are no fiber ferrule and no housing in this design. Specially designed lens 6 and optical fiber 107 are mechanically attached with a heat-shrinkable tube 5. The fabrication cost for this design is low compared to the designs shown in FIGS. 1 through 4. Nevertheless, the yield for obtaining high performance optical fiber collimators using this design is low compared to designs shown in FIGS. 1 through 4 because the optical alignment between lens 6 and optical fiber 107 can be perturbed when heat is applied to heat-shrinkable tube 5 to mechanically attach lens 6 to optical fiber 107. Further, external mechanical forces can easily perturb the optical alignment of this design because heat-shrinkable tube 5 is not rigid. Additionally, for this collimator to achieve high optical transmission performance, optical fiber 107 and the portion of lens 6 that is in heat-shrinkable tube 5 must have similar diameters and the light-collecting surface of lens 6 must be large compared to the cross-sectional surface of optical fiber 107. These design constraints on the size and the shape of lens 6 increase the cost of this optical fiber collimator.

With the advent of low cost laser signal sources for optical fiber systems, there is an enormous price pressure on the passive components employed in optical fiber systems. Passive optical components, including optical fiber collimators, become commodities. Low cost replaces optimal optical transmission performance as the most important design goal for optical fiber collimators in many optical communication applications. It is therefore one of the objectives of this invention to provide an optical fiber system with an improved optical fiber collimator.

### SUMMARY OF THE INVENTION

According to this invention, an optical fiber system with improved cost performance can be achieved through employing an improved optical fiber collimator that has reduced parts count and a simplified fabrication process. Optical transmission performance of the improved optical fiber collimator is achieved through designing in a mechanism that allows for the adjustment of the relative distance between the collimating lens and the optical fiber termination, and the adjustment of other applicable parameters.

An embodiment of this invention employs an improved optical fiber collimator. This improved optical fiber collimator includes a housing that has a first channel and a second channel. The first channel is coupled to the second channel. An optical fiber extends into the housing through the first channel. The optical fiber terminates in the housing. A collimating lens locates in the second channel of the housing. The collimating lens may be partially or totally in the second channel. The optical fiber is optically coupled to the collimating lens.

A method for fabricating this improved optical fiber collimator includes the following steps: installing an end portion of the optical fiber and the collimating lens in the housing; aligning the collimating lens and the end portion of the optical fiber in the housing; attaching the end portion of the optical fiber and the collimating lens if they are not attached to the housing during installation.

### DESCRIPTION OF THE DRAWINGS

A better understanding of the invention may be gained from the consideration of the following detailed description taken in conjunction with the accompanying drawings in which:

FIG. 1 shows the configuration of a conventional optical fiber collimator for an optical fiber system.

FIG. 2 shows the configuration of an improved optical fiber collimator for an optical fiber system, which allows for the adjustments of the relative distance between the collimating lens and the optical fiber end portion to achieve optimal optical transmission performance.

FIG. 3 shows the configuration of another improved optical fiber collimator for an optical fiber system, which allows the adjustment of the relative position between the collimating lens and the optical fiber end portion, and the angle between the optical axis of the collimating lens and the optical axis of the optical fiber end portion to achieve optimal optical transmission performance.

FIG. 4 shows the configuration of another improved optical fiber collimator for an optical fiber system, which allows for the adjustment of the relative distance between the collimating lens and the optical fiber end portion, and the offset between the optical axis of the collimating lens and the optical fiber end portion to achieve optimal optical transmission performance.

FIG. 5 shows the configuration of another conventional optical fiber collimator for an optical fiber system.

FIG. 6 shows the configuration of the improved optical fiber collimator employed in an embodiment of the present invention.

FIG. 7 is a sectional view of a representative housing of the improved optical fiber collimator shown in FIG. 6.

FIG. 8 shows the configuration of the alternative improved optical fiber collimator employed in an alternative embodiment of the present invention.

### DETAILED DESCRIPTION OF THE INVENTION

In the description that follows, like parts are indicated throughout the specification and drawings with the same reference numerals. The present invention is not limited to the specific embodiments illustrated herein.

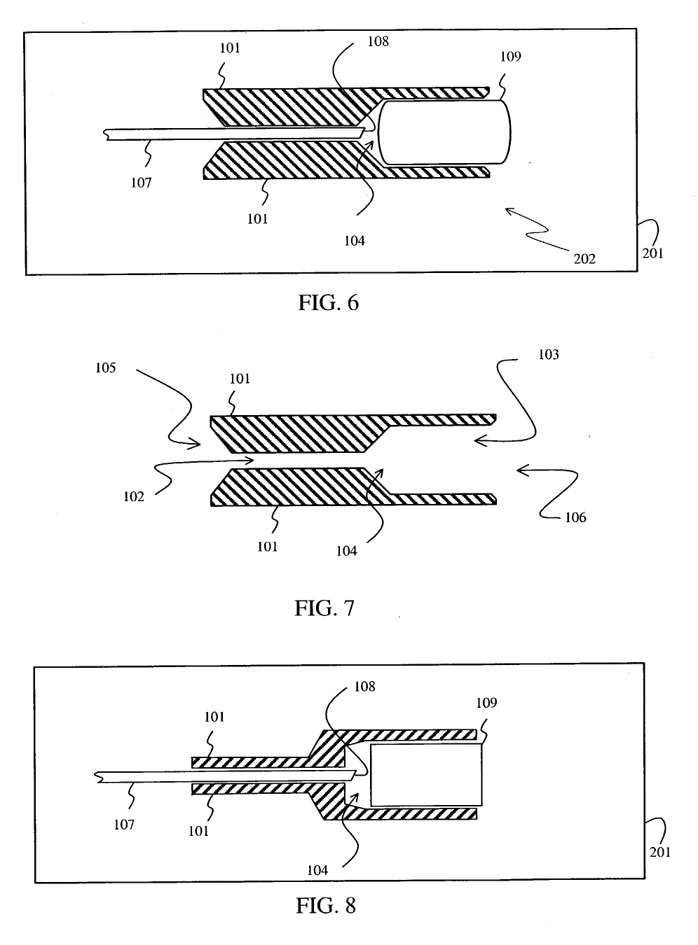

FIG. 6 shows the configuration of an improved optical fiber collimator employed in an embodiment of this invention. Optical fiber system 201 includes an improved optical fiber collimator 202 and other optical components not shown in FIG. 6. FIG. 7 shows a sectional view of a representative housing of the improved optical fiber collimator 202 shown in FIG. 6. Referring to FIG. 7, housing 101 has a first channel 102 and a second channel 103. First channel 102 and second channel 103 are generally tubular-shaped and share a common axis. Because first channel 102 and second channel 103 may have different diameters, there is optional transition region 104 between first channel 102 and second channel 103. Entrance to first channel 105 and entrance to second channel 106 are tapered. Housing 101 provides structural support to the embodiment.

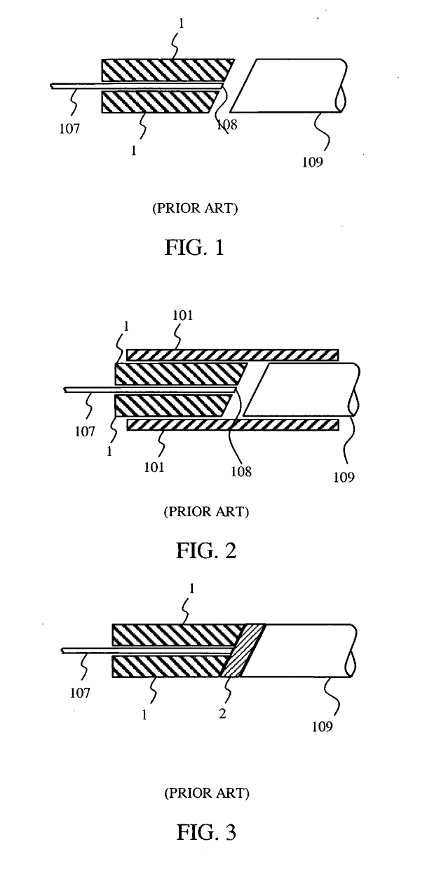

Referring to FIGS. 6 and 7, the end portion of optical fiber 107 is located in first channel 102 of housing 101. The inner diameter of first channel 102 is larger than the outer diameter of optical fiber 107. Therefore, optical fiber 107 may slide inside first channel 102. At the end of optical fiber 107 is optical fiber termination 108. There are numerous methods to form optical fiber termination 108. A typical method is to cleave optical fiber 107. The surface at optical fiber termination 108 is at an angle to the plane that is perpendicular to the optical axis of the end option of optical fiber 107. Ones skilled in the art readily understands that by keeping this angle to be positive and small, typically between one degree and ten degrees, will help to reduce transmission loss and reflection of the embodiment. When the end portion of optical fiber 107 is installed in first channel 102 as shown in FIG. 6, the optical axis of the end portion of optical fiber 107 is the same as the axis of first channel 102. To further reduce transmission loss and reflection, optical fiber termination 108 has an optional anti-reflection coating. The fiber ferrule 1 in the prior arts shown in FIG. 1 through 4 is eliminated in this invention.

Referring to FIGS. 6, the cross section of collimating lens 109 on the plane that is perpendicular to the optical axis of collimating lens 109 has the shape of a circle. The diameter of this circle is the diameter of the body of collimating lens 109. At least a portion of collimating lens 109 is located in second channel 103. The inner diameter of second channel 103 is larger than the outer diameter of the body of collimating lens 109. Therefore collimating lens 109 may slide inside second channel 103. Collimating lens 109 employed in this embodiment is a spherical drum lens. The surface of collimating lens 109 has an optional anti-reflection coating to maximize optical transmission and minimize reflection.

The fabrication process of an improved optical fiber collimator employed in an embodiment of the present invention includes the following tasks and one skilled in the art readily understands that it is not necessary to execute these tasks in the following sequence to successfully fabricate the embodiment:

Install collimating lens 109 in second channel 103 of housing 101;

Attach collimating lens 109 to housing 101, preferably with a securing means such as an adhesive;

Insert optical fiber 107 into first channel 102 of housing 101 through entrance to first channel 105;

Align the embodiment by adjusting the position of optical fiber termination 108 in housing 101 by sliding optical fiber 107 in first channel 102 to achieve desirable optical transmission characteristics; and

Attach the end portion of optical fiber 107 to housing 101, preferably with a securing means such as an adhesive.

Further, one skilled in the art understands that:

The task of installing the end portion of optical fiber 107 into housing 101 and the task of installing collimating lens into housing 101 should be completed before the task of aligning collimating lens 109 and the end portion of optical fiber 107 in housing 101;

The task of installing the end portion of optical fiber 107 into housing 101 should be completed before the task of attaching the end portion of optical fiber 107 to housing 101;

The task of installing collimating lens 109 into housing 101 should be completed before the task of attaching collimating lens 109 to housing 101; and

The task of aligning collimating lens 109 and the end portion of optical fiber 107 in housing 101 should be completed before both the tasks of attaching the end portion of optical fiber 107 to housing 101 and the task of task of attaching collimating lens 109 to housing 101 are completed.

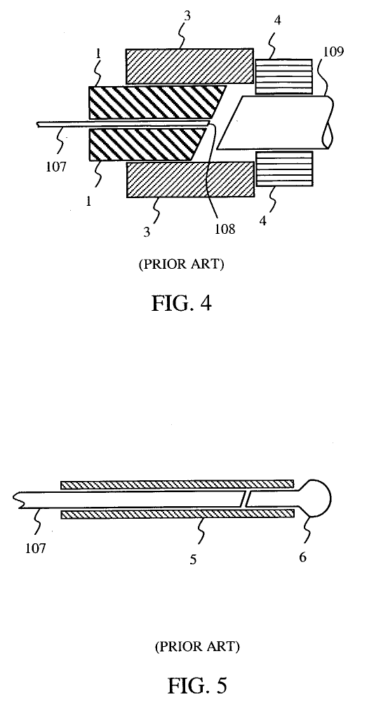

When compared to some of the prior art designs, the embodiment shown in FIG. 6 has fewer parameters available for alignment to achieve high optical transmission performance. Although this embodiment has fewer parameters available for alignment, empirical results show that the optical transmission performance of the embodiment and those of the prior arts that have numerous alignment parameters are comparable. An example of a prior art that have numerous alignment parameters is shown in FIG. 4. Because this embodiment has fewer parts and fewer alignment parameters available, the total manufacturing cost, including material cost, tooling cost, inventory cost, and labor cost is reduced compared to the optical fiber collimator shown in FIG. 4.

FIG. 8 illustrates an alternative improved optical fiber collimator employed in an alternative embodiment of this invention. A gradient index (GRIN) lens is employed as collimating lens 109 in this embodiment instead of the spherical drum lens shown in FIG. 6. The entrance to the second channel is not tapered. Housing 101 has relatively uniform wall thickness and optional transition region 104 has a different design.

There are numerous variations to the embodiments discussed above which will be trivial to the one skilled in the art. Examples of these variations include but not limited to:

The cross section of the channel along the axis of first channel 102 is not circular, common alternatives include polygon-shaped, star-shaped, or irregular-shaped;

The cross section of the channel along the axis of first channel 102 is not uniform, common alternatives include tapered or irregular;

The cross section of the channel along the axis of second channel 103 is not circular, common alternatives include polygon-shaped, star-shaped, or irregular-shaped;

The cross section of the channel along the axis of second channel 103 is not uniform, common alternatives include tapered or irregular;

The entrance to first channel 105 may be tapered or not tapered;

The entrance to second channel 106 may be tapered or not tapered;

Other types of lens such as aspheric lens or asymmetrical lens may be employed as a collimating lens;

The single collimating lens is replaced by a lens system that includes one or more lenses;

The lens system has its own supporting structure;

The cross section of collimating lens 109 on the plane that is perpendicular the optical axis of collimating lens 109 has a shape other than that of a circle;

The collimating lens has shape other than the rod shape illustrated, such as a truncated snow cone shaped;

The alignment of the embodiment includes adjusting other than the distance between optical fiber termination 108 and collimating lens, such as the relative angular orientation about their optical axes; and

Optical fiber 107 or collimating lens 109 is attached to housing 101 through mechanical methods.

Although the embodiment of the invention has been illustrated and that the form has been described, it is readily apparent to those skilled in the art that various modifications may be made therein without departing from the spirit of the invention.

What is claimed is:

1. An optical fiber system, comprising:
at least one optical component;
an optical fiber network having at least one optical fiber; and
an optical fiber collimator providing optical coupling between said optical component and said optical fiber network;
wherein, said optical fiber collimator, comprising:
a housing having a first channel and a second channel, said first channel being coupled to said second channel;
an optical fiber of said optical fiber network extending to said housing having an optical fiber termination in said housing, an end portion of said optical fiber being in said first channel and at least a portion of said end portion in said first channel being mechanically supported directly by said housing; and
a collimating lens system in said second channel being in optical communication with said optical fiber of said optical fiber network.

2. The optical fiber system as claimed in claim 1, wherein, the entrance to said first channel is tapered.

3. The optical fiber system as claimed in claim 1, wherein, said first channel has a circular cross section.

4. The optical fiber system as claimed in claim 1, wherein, said first channel has a polygon-shaped cross section.

5. The optical fiber system as claimed in claim 1, wherein, said first channel is uniform along said first channel.

6. The optical fiber system as claimed in claim 1, wherein, said first channel is tapered along said first channel.

7. The optical fiber system as claimed in claim 1, wherein, the entrance to said second channel is tapered.

8. The optical fiber system as claimed in claim 1, wherein, said second channel has a circular cross section.

9. The optical fiber system as claimed in claim 1, wherein, said second channel has a polygon-shaped cross section.

10. The optical fiber system as claimed in claim 1, wherein, said second channel is uniform along said second channel.

11. The optical fiber system as claimed in claim 1, wherein, said second channel is tapered along said second channel.

12. The optical fiber system as claimed in claim 1, wherein, said optical fiber termination is formed by cleaving said optical fiber.

13. The optical fiber system as claimed in claim 1, wherein, said optical fiber termination is polished.

14. The optical fiber system as claimed in claim 1, wherein, said optical fiber termination has an anti-reflection coating.

15. The optical fiber system as claimed in claim 1, wherein, the normal to the surface of said optical fiber termination is at a positive angle with respect to the optical axis of said optical fiber at said optical fiber termination.

16. The optical fiber system as claimed in claim 1, wherein, the normal to the surface of said optical fiber termination is at a zero degree angle with respect to the optical axis of said optical fiber at said optical fiber termination.

17. The optical fiber system as claimed in claim 1, wherein, said collimating lens system comprises a spherical lens.

18. The optical fiber system as claimed in claim 1, wherein, said collimating lens system comprises a gradient index lens.

19. The optical fiber system as claimed in claim 1, wherein, said collimating lens system comprises an aspheric lens.

20. The optical fiber system as claimed in claim 1, wherein, said collimating lens system comprises an asymmetrical lens.

21. The optical fiber system as claimed in claim 1, wherein, said collimating lens system comprises a plurality of lenses.

22. The optical fiber system as claimed in claim 1, wherein, said collimating lens system comprises a support structure.

23. The optical fiber system as claimed in claim 1 further comprise a transition region in said housing coupling said first channel to said second channel.

24. The optical fiber system as claimed in claim 23, wherein, said optical fiber termination is in said transition region.

25. The optical fiber system as claimed in claim 1, wherein, said optical fiber termination is in said second channel.

26. The optical fiber system as claimed in claim 1, wherein, said optical fiber termination is in said first channel.

27. The optical fiber system as claimed in claim 1, wherein, said collimating lens system is attached to said housing with an adhesive.

28. The optical fiber system as claimed in claim 1, wherein, said optical fiber is attached to said housing with an adhesive.

29. The optical fiber system as claimed in claim 28, wherein, said collimating lens system is attached to said housing with an adhesive.

30. The optical fiber system as claimed in claim 29, wherein, the normal to the surface of said optical fiber termination is at a positive angle with respect to the optical axis of said optical fiber at said optical fiber termination.

31. The optical fiber system as claimed in claim 30, wherein, said optical fiber termination has an anti-reflection coating.

32. The optical fiber system as claimed in claim 31, wherein, said collimating lens comprises a spherical lens.

33. The optical fiber system as claimed in claim 32, wherein, said first channel has a circular cross section.

34. The optical fiber system as claimed in claim 33, wherein, said second channel has a circular cross section.

35. The optical fiber system as claimed in claim 34, wherein, the entrance to said first channel is tapered.

36. The optical fiber system as claimed in claim 35, wherein said optical fiber termination is formed by cleaving said optical fiber.

36. The optical fiber system as claimed in claim 31, wherein, said collimating lens comprises a gradient index lens.

38. The optical fiber system as claimed in claim 37, wherein, said first channel has a circular cross section.

39. The optical fiber system as claimed in claim 38, wherein, said second channel has a circular cross section.

40. The optical fiber system as claimed in claim 39, wherein, the entrance to said first channel is tapered.

41. The optical fiber system as claimed in claim 40, wherein said optical fiber termination is formed by cleaving said optical fiber.

41. The optical fiber collimator as claimed in claim 30, wherein, said collimating lens comprises an aspheric lens.

42. An optical fiber system, comprising:
at least one optical component;
an optical fiber network having at least one optical fiber; and
an optical fiber collimator being disposed to couple said optical component to said optical fiber network;
wherein, said optical fiber collimator, comprising:
a housing;
an optical fiber of said optical fiber network extending into said housing having an optical fiber termination in said housing, at least approximately half of the length of the portion of said optical fiber in said housing being supported directly by said housing; and
a collimating lens system disposed at least partially in said housing for collimating a least a portion of light from said optical fiber through said optical fiber termination into a substantially collimated light beam outside said housing and collecting light from the outside of said housing into said optical fiber through said optical fiber termination.

44. The optical fiber system as claimed in claim 43, wherein, said optical fiber is attached to said housing with an adhesive.

45. The optical fiber system as claimed in claim 44, wherein, said collimating lens system is attached to said housing with an adhesive.

46. The optical fiber system as claimed in claim 45, wherein, the normal to the surface of said optical fiber termination is at a positive angle with respect to the optical axis of said optical fiber at said optical fiber termination.

47. The optical fiber system as claimed in claim 46, wherein, said optical fiber termination has an anti-reflection coating.

48. The optical fiber system as claimed in claim 47, wherein, said collimating lens comprises a spherical lens.

49. The optical fiber system as claimed in claim 47, wherein, said collimating lens comprises a gradient index lens.

50. The optical fiber system as claimed in claim 47, wherein, said collimating lens comprises an aspheric lens.

51. The optical fiber system as claimed in claim 47, wherein, said collimating lens comprises an asymmetrical lens.

52. The optical fiber system as claimed in claim 45, wherein, the normal to the surface of said optical fiber termination is at a zero degree angle with respect to the optical axis of said optical fiber at said optical fiber termination.

53. An optical fiber system, comprising:
at least one optical components;
an optical fiber network having at least one optical fiber; and
an optical fiber collimator being disposed to couple said optical component to said optical fiber network;
wherein, the method of fabricating said optical fiber collimator comprising:
installing a collimating lens system in the housing of said optical fiber collimator;
installing an end portion of an optical fiber in said housing;
aligning said collimating lens system and said end portion of said optical fiber in said housing after installing said end portion of said optical fiber and said collimating lens system in said housing; and
attaching a first element selected from the group consisting of said end portion of said optical fiber and said collimating lens system to said housing after aligning said collimating lens system and said end portion of said optical fiber in said housing.

54. The optical fiber system as claimed in claim 53, wherein, said method of fabricating said optical fiber collimator, further comprising:
attaching a second element selected from the group consisting of said end portion of said optical fiber and said collimating lens system to said housing before aligning said collimating lens system and said end portion of said optical fiber in said housing and after installing said second element in said housing.

55. The optical fiber system as claimed in claim 54, wherein, said first element is different from said second element.

56. The optical fiber system as claimed in claim 54, wherein, said second element is said collimating lens system.

57. The optical fiber system as claimed in claim 53, wherein, said first element is said end portion of said optical fiber.

58. The optical fiber system as claimed in claim 53, wherein, said end portion of said optical fiber is installed in said housing before said collimating lens system is installed in said housing.

59. The optical fiber system as claimed in claim 53, wherein, said end portion of said optical fiber is installed in said housing after said collimating lens system is installed in said housing.

60. The optical fiber system as claimed in claim 55, wherein:
said first element is said end portion of said optical fiber; and
said second element is said collimating lens system.

61. The optical fiber system as claimed in claim 60, wherein, said end portion of said optical fiber is installed in said housing before said collimating lens system is installed in said housing.

62. The optical fiber system as claimed in claim 60, wherein, said end portion of said optical fiber is installed in said housing after said collimating lens system is installed in said housing.

63. The optical fiber system as claimed in claim 62, wherein, said end portion of said optical fiber is installed in said housing after said collimating lens system is installed and attached to said housing.
